(19) United States
(12) Patent Application Publication
(10) Pub. No.: US 2007/0075958 A1
(43) Pub. Date: Apr. 5, 2007

(54) Liquid crystal display device and method for driving the same

(75) Inventor: Jong Hoon Kim, Gyeonggi-do (KR)

Correspondence Address: JENKENS & GILCHRIST, P.C., 901 15TH STREET N.W., SUITE 900, WASHINGTON, DC, 20005, US

(73) Assignee: LG.PHILIPS LCD CO., LTD., Seoul (KR)

(21) Appl. No.: 11/475,914

(22) Filed: Jun. 28, 2006

(30) Foreign Application Priority Data
Sep. 30, 2005 (KR) 10-2005-0092260

(51) Int. Cl. G09G 3/36

(52) U.S. Cl. 345/98

(57) ABSTRACT

A liquid crystal display device includes a timing controller for outputting a digital data signal to display images and a clock signal for sampling the digital data signal, and a data restorer for generating a reference voltage based on the clock signal from the timing controller, comparing the voltage level of digital data signal outputted from the timing controller with the reference voltage, converting the voltage level of inputted digital data signal to one of preset voltages, and supplying the converted voltage level to a data driver integrated circuit.

This application claims the benefit of the Korean Patent Application No. P2005-0092260, filed on Sep. 30, 2005, which is hereby incorporated by reference in its entirety.

### BACKGROUND OF THE INVENTION

1. Field of the Invention

The present invention relates to a display device, and more particularly, to a liquid crystal display (LCD) device and a method for driving the same. Although the present invention is suitable for a wide scope of applications, it is particularly suitable for preventing misoperation of a comparator in an LCD device.

2. Discussion of the Related Art

In general, a cathode ray tube (CRT), which is one type of flat display device, cannot meet the demands for compact size and lightweight due to the size and weight of the CRT itself. Thus, various types of other flat display devices, such as a liquid crystal display (LCD) device using electro-optical field optical effect, a plasma display panel (PDP) using gas discharge, a filed emission display device using electron emission, and an electroluminescence display (ELD) device using an electric field luminous effect, have been studied for substitution of the CRT.

The LCD device includes a TFT substrate, a color filter substrate and a liquid crystal layer between the TFT substrate and the color filter substrate. The TFT substrate has a plurality of liquid crystal cells in pixel regions defined by gate lines and data lines, and thin film transistors positioned where the gate lines and the data lines cross. Each of the thin film transistors functions as a switching device for the liquid crystal cells. The color filter substrate has a color filter layer facing the TFT substrate with a predetermined gap therebetween. The liquid crystal layer is provided between the TFT substrate and the color filter substrate. In the LCD device, an electric field is formed across the liquid crystal layer corresponding to a data signal, thereby obtaining the desired picture image by controlling the transmissivity of light passing through the liquid crystal layer in accordance with the intensity of the electric field.

FIG. 1 is a schematic view of a driving apparatus of an LCD device according to the related art. As shown in FIG. 1, the driving apparatus includes an LCD panel 10, a data driver 40, a gate driver 50, and a timing controller 30. The LCD panel 10 includes liquid crystal cells defined by ‘n’ gate lines (GL1 to GLm) and ‘m’ data lines (DL1 to DLm). The data driver 40 supplies analog data signals to the data lines (DL1 to DLm). The gate driver 50 supplies scan pulses to the gate lines (GL1 to GLm). The timing controller 30 aligns digital data signals (Data) inputted from an external device to be suitable for driving of the LCD panel 10, and then supplies the aligned digital data signal (Data) to the data driver 40. The timing controller 30 also controls both the data driver 140 and the gate driver 150.

The LCD panel 10 includes thin film transistors (TFTs) adjacent to where the ‘n’ gate lines (GL1 to GLm) cross the ‘m’ data lines (DL1 to DLm) within the liquid crystal cells. The ‘n ’gate lines (GL1 to GLm) cross the ‘m ’data lines (DL1 to DLm) are connected to the thin film transistors (TFTs). In respond to scan pulses on the gate lines (GL1 to GLn) and data signals on the data lines (DL1 to DLm), the thin film transistors (TFTs) supply the data signals to the liquid crystal cells. Each of the liquid crystal cells includes a common electrode and a sub-pixel electrode facing each other with liquid crystal interposed therebetween. Thus, the liquid crystal cell has the structure of a liquid crystal capacitor (Clc). The sub-pixel electrode is connected with a data line via the thin film transistor (TFT) when a scan pulse is applied to the gate line connected to a gate of the thin film transistor. A portion of the pixel electrode overlies a preceding gate line so as to maintain the data signal charged in the liquid crystal capacitor (Clc) until the next data signal is charged.

The timing controller 30 aligns the digital data signals (Data) inputted from an external device to be suitable for driving of the LCD panel 10, and then supplies the aligned digital data signal (Data) to the data driver 40. The timing controller 30 also generates a data control signal (DCS) and a gate control signal (GCS) in accordance with a clock signal (DCLK), a data enable signal (DE), horizontal and vertical synchronization signal (Hsync, Vsync) inputted from the external device. The control signal (DCS) and a gate control signal (GCS) control the driving timing of the data driver 40 and the gate driver 50.

The gate driver 50 includes a shift register which sequentially generates gate high pulses in response to the gate control signal (GCS) from the timing controller 30. The gate driver 150 includes a plurality of gate driver ICs for the shift register.

The data driver 40 includes a plurality of data driver ICs for supplying the analog data signals to the data lines (DL) of the LCD panel 10. Each of the data drive ICs converts the digital data signal (Data) aligned in the timing controller 30 based on the data control signal (DCS) supplied from the timing controller 30 to the analog data signal, and supplies the analog data signal for one horizontal line to the data lines (DL1 to DLm) by one horizontal period for supplying the scan pulse to the gate lines (GL1 to GLn). Each of the data drive ICs generates a plurality of gamma voltages having the different voltage values corresponding to the gray scale number of the data signal (Data), selects one gamma voltage as the analog data signal based on the gray scale value of the digital data signal (Data), and supplies the selected gamma voltage to the data lines (DLl to DLm).

In the driving apparatus of the LCD device according to the related art, the timing controller 30 converts the digital data signal (Data) to the TTL/CMOS level according to the CMOS interface method, and parallel-transmits the converted digital data (Data) to the data driver 40 by the 1 to 1 port method or the 2 to 2 port method. In the meantime, the digital data signal (Data) outputted from the timing controller 30 is about 0.6V to 1.5V. Generally, the level of digital data signal (Data) is about 3.3V. However, the timing controller 30 lowers the level of digital data signal (Data) below 3.3V. Thus, the digital data signal (Data) can be transmitted at a high speed above 100 MHz. Since the timing controller 30 lowers the voltage level of digital data signal (Data), the possibility of electromagnetic interference (EMI) with the digital data signal (Data) while being transmitted through a data transmission line is decreased.

The digital data signal (Data) outputted from the timing controller 30 is supplied to each of the data driver ICs. Each of the data driver ICs restores the voltage level of the supplied digital data signal (Data) to 3.3V. To restore this voltage level, each of the data driver ICs includes a data restorer for restoring the digital data signal (Data) having the voltage level of 0.6V to 1.5V to the original voltage level of 3.3V.

FIG. 2 is a schematic view of a data restorer in each of data driver ICs for the data driver of FIG. 1. As shown in FIG. 2, the data restorer 201 includes a reference voltage generator 201a for generating a reference voltage (Vref), and a comparator 201b. The comparator 201b compares the digital data signal (Data) supplied from the timing controller 130 with the reference voltage (Vref) generated from the reference voltage generator 201a. According to the compared result, the comparator 201b outputs a high or low logic digital data signal (Data).

The digital data signal (Data) is supplied to the comparator 201b through a data transmission line 222 by bit. Then, the comparator 201b compares the inputted voltage corresponding to each bit with the reference voltage (Vref). If the voltage of the corresponding bit is larger than the reference voltage (Vref) (that is, the bit has the digital data value of the high logic), the comparator 201b outputs the preset high-level voltage for the voltage of the bit. If the voltage of the corresponding bit is smaller than the reference voltage (Vref) (that is, the bit has the digital data value of the low logic), the comparator 201b outputs the preset low-level voltage for the voltage of the bit.

As explained above, the high-level voltage value is 3.3V. The low-level voltage value is 0V. Accordingly, the digital data signal (Data) is converted to the restored digital data signal (Data ′) of 3.3V by the comparator 201b. For the operation of the comparator 201b to be precise, the voltage level of reference voltage (Vref) inputted from the comparator 201b is maintained as an intermediate voltage of the digital data signal (Data) outputted from the timing controller 130. Thus, the reference voltage (Vref) has an intermediate voltage between the bit having the digital data voltage of high logic and the bit having the digital data voltage of low logic. If the reference voltage (Vref) is not maintained at the intermediate voltage, the comparator 201b may misoperate.

As the digital data signal (Data) outputted from the timing controller 130 passes through the data transmission line 222, the digital data signal (Data) is distorted due to the resistance and the capacitance components of the data transmission line 222. Accordingly, the voltage for each bit of the digital data signal (Data) may be smaller or larger than the desired value. As explained above, since the reference voltage (Vref) is fixed, the reference voltage (Vref) may not be at the intermediate voltage of the actual digital data signal (Data) as the voltage level of the digital data signal (Data) are affected by the resistance and capacitance components of the data transmission line. Thus, the comparator 201b may have misoperations.

### SUMMARY OF THE INVENTION

Accordingly, the present invention is directed to an LCD device and a method for driving the same, which substantially obviate one or more problems due to limitations and disadvantages of the related art.

An object of the present invention is to provide an LCD device and a method for driving the same to prevent misoperation of a comparator.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a liquid crystal display device includes a timing controller for outputting a digital data signal to display images and a clock signal for sampling the digital data signal, and a data restorer for generating a reference voltage based on the clock signal from the timing controller, comparing the voltage level of digital data signal outputted from the timing controller with the reference voltage, converting the voltage level of inputted digital data signal to one of preset voltages, and supplying the converted voltage level to a data driver integrated circuit.

In another aspect of the present invention, a method for driving a liquid crystal display device having a liquid crystal display panel for displaying images includes outputting a digital data signal to display images, outputting a clock signal to sample the digital data signal, generating a reference voltage that is an intermediate voltage of the clock signal, comparing a voltage level of the digital data signal with the reference voltage, and converting the voltage level of digital data signal to any one of preset voltages according to the compared result, and outputting the converted voltage level.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a schematic view of a driving apparatus of an LCD device according to the related art;

FIG. 2 is a schematic view of a data restorer in each of data driver ICs for the data driver of FIG. 1;

FIG. 3 illustrates an LCD device according to an embodiment of the present invention;

FIG. 4 illustrates a connection between a timing controller and data driver ICs of FIG. 3;

FIG. 5 illustrates a data restorer provided in each of data driver ICs of FIG. 3;

FIG. 6 illustrates a waveform of reference voltage outputted from a reference voltage generator of FIG. 5; and

FIG. 7 is a schematic view of a data driver IC in FIG. 3.

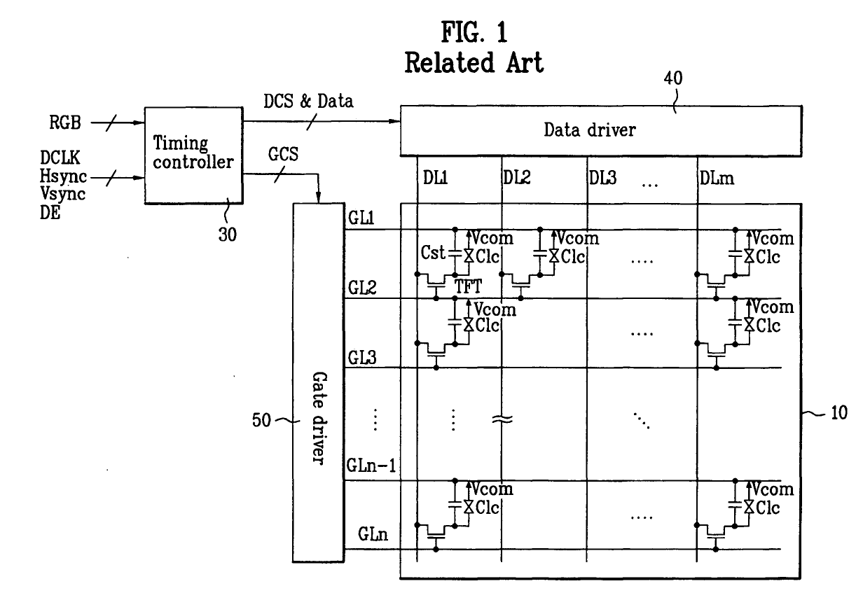

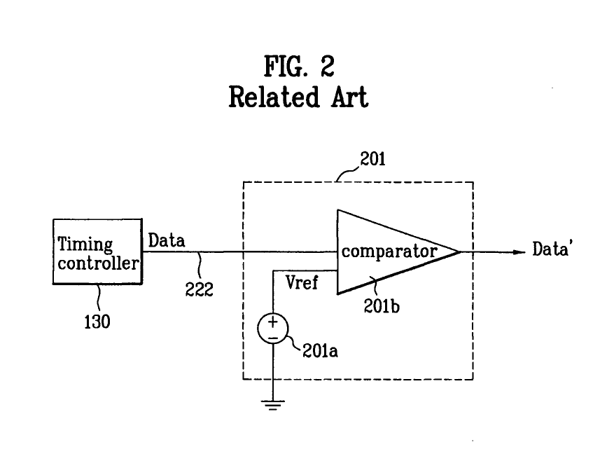

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

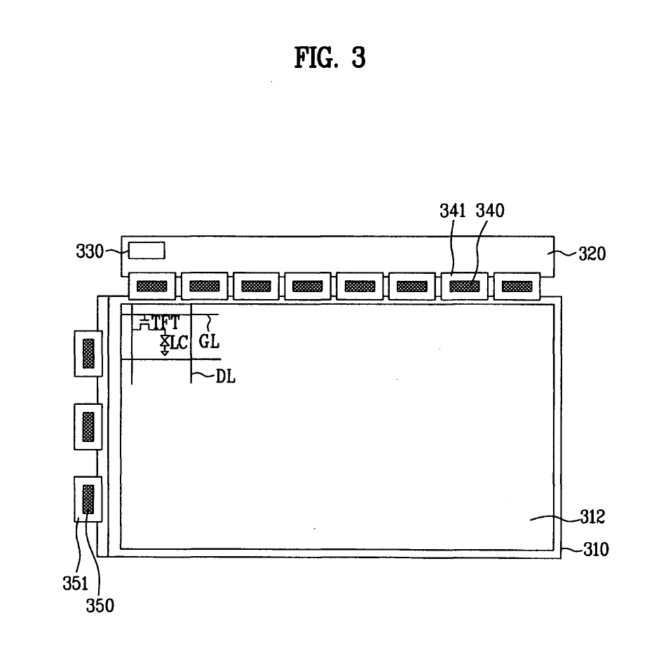

FIG. 3 illustrates an LCD device according to an embodiment of the present invention. As shown in FIG. 3, the LCD device according to an embodiment of the present invention includes an LCD panel 310, a plurality of gate driver ICs 350, a plurality of data driver ICs 340, and a timing controller 330. The LCD panel 310 has a display area 312 for displaying images. The plurality of gate driver ICs 350 supply scan pulses to the LCD panel 310. The plurality of data driver ICs 340 supply analog data signals to the LCD panel 310. The timing controller 330 also aligns digital data signals (Data) inputted from an external device to be suitable for driving the LCD panel 310, and then supplies the aligned digital data signal (Data) to the data driver 340. The timing controller 330 also controls the data driver 340 and the gate driver 350.

The timing controller 330 and a power circuit (not shown) are provided on a printed circuit board (PCB) 320. A plurality of tape carrier packages (TCPS) 341 are adhered to the PCB 320 and the LCD panel 310 between the PCB 320 and the LCD panel 310. Each of the TCPs 341 have a data driver integrated circuit (IC) 340 being mounted thereon. A plurality of gate TCPs 351 are adhered to the LCD panel 310. Each gate TCP 351 has a gate driver integrated circuit (IC) 351 mounted thereon.

The LCD panel 310 displays images by controlling the light-transmittance of liquid crystal cells (LC) formed in a matrix-type configuration. Each of the liquid crystal cells includes a thin film transistor (TFT) formed adjacent to a crossing of a gate line (GL) and a data line (DL). The thin film transistor (TFT) functions as a switch. An analog data signal is applied to the data lines (DL) from the data driver IC 340.

Each data TCP 341 is adhered between the PCB 320 and the LCD panel 310 by tape automated bonding (TAB). Input pads of the data TCP 341 are electrically connected with the PCB 320 and output pads of the data TCP 341 are electrically connected with data pads of the LCD panel 310. Each gate TCP 341 is electrically connected with gate pads of the LCD panel 310 by TAB.

The timing controller 330, the power circuit, and a reference gamma voltage generator (not shown) for supplying a reference gamma voltage to the data driver ICs 340 are on the PCB 320. The PCB 320 also has signal lines (not shown) for electric connection of components. The timing controller 330 generates a data control signal (DCS) and a gate control signal (GCS) using a main clock signal (MCLK), a data enable signal (DE), and horizontal and vertical synchronization signals (Hsync, Vsync) inputted from the external through a user connector (not shown), and controls the driving timing of the data driver ICs 340 and the gate driver ICs 350.

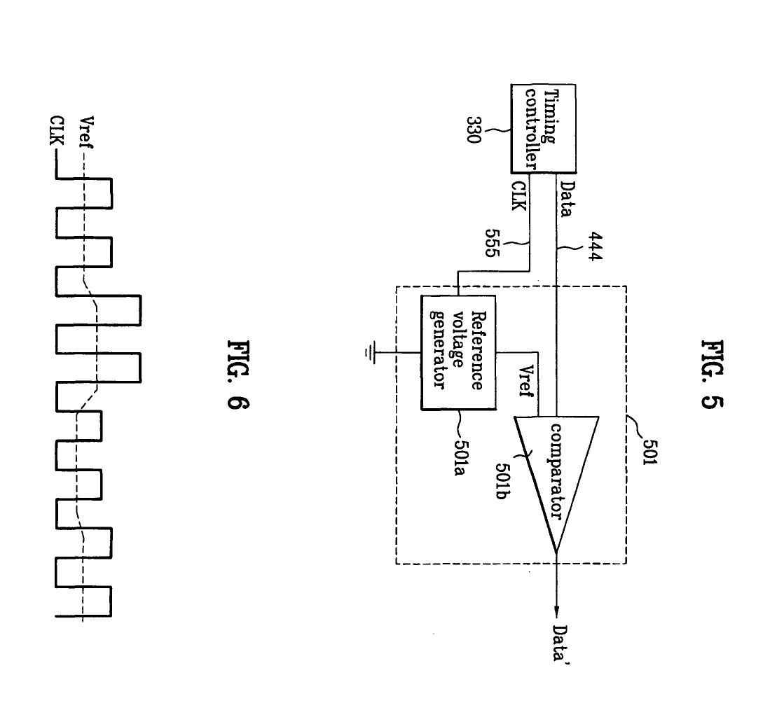

FIG. 4 illustrates the connection between the timing controller and the data driver ICs of FIG. 3. As shown in FIG. 4, the plurality of data driver ICs 340 are connected with the timing controller 330 by a plurality of data transmission lines 444 and control signal transmission lines 424. The plurality of control signal transmission lines 424 include a clock transmission line, which transmits the clock signal for sampling the digital data signal (Data).

The data driver ICs 340 are sequentially operated according to the data control signal (DCS) supplied from the timing controller 330 through the plurality of control signal transmission lines 424. The digital data signal (Data) outputted from the timing controller 330 is transmitted to the data driver ICs 340 through the plurality of data transmission lines 444. Also, each data driver IC 340 converts the inputted digital data signal (Data) to the analog signal, and supplies the analog signal to the data lines (DL) of the LCD panel 310.

The digital data signal (Data) outputted from the timing controller 330 is about 0.6V to 1.5V. Generally, a level of digital data signal (Data) is about 3.3V. However, the timing controller 330 lowers the level of digital data signal (Data) below 3.3V. Thus, the digital data signal (Data) can be transmitted at a high speed above 100 MHz. As the timing controller 330 lowers the voltage level of digital data signal (Data), the effect of possible electromagnetic interference (EMI) on the digital data signal (Data) while being transmitted through the data transmission line 444 is decreased.

The digital data signal (Data) outputted from the timing controller 330 is supplied to the data driver ICs 340. Each of the data driver ICs restores the voltage level of the supplied digital data signal (Data) to about 3.3V. To restore this voltage, each of the data driver ICs includes a data restorer for restoring the digital data signal (Data) having the voltage level of about 0.6V to 1.5V to the original voltage level of about 3.3V.

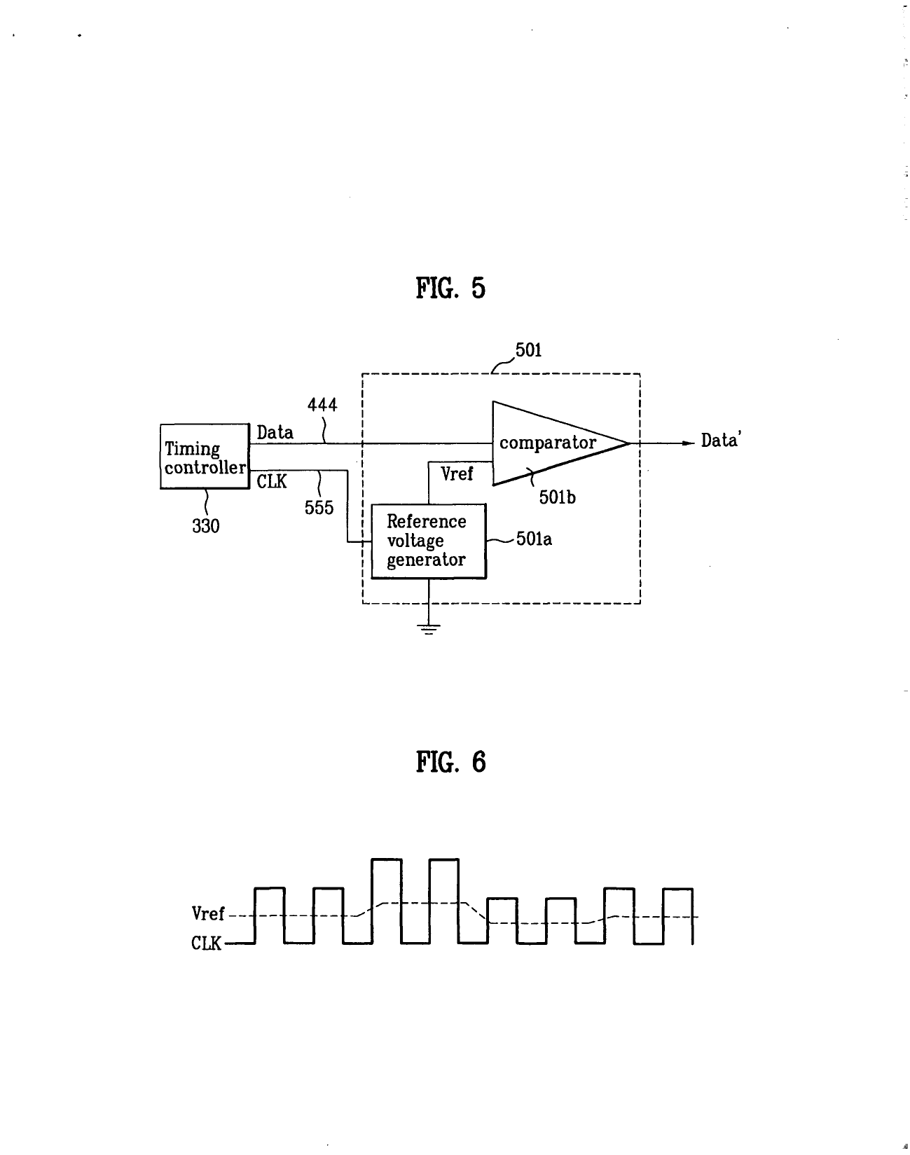

FIG. 5 illustrates a data restore provided in each of data driver ICs of FIG. 3. As shown in FIG. 5, the data restorer 501 includes a reference voltage generator 501a and a comparator 501b. As the clock signal (CLK) outputted from the timing controller 330 is supplied to the reference voltage generator 501a, the reference voltage generator 501a outputs a reference voltage (Vref) of an intermediate voltage between high and low logic voltages of the clock signal (CLK). Then, the comparator 501b compares the reference voltage (Vref) outputted from the reference voltage generator 501a with the voltage level of digital data signal (Data) outputted from the timing controller 330. According to the compared result, the comparator 501b selects a high-level or low-level voltage and outputs the selected one.

The digital data signal (Data) is supplied to the comparator 501b through the data transmission line 444 by bit. Then, the comparator 501b compares the inputted voltage corresponding to each bit with the reference voltage (Vref). If the voltage of the corresponding bit is larger than the reference voltage (Vref), such as the high logic voltage, the comparator 501b outputs the preset high-level voltage for the voltage of the bit. If the voltage of the corresponding bit is smaller than the reference voltage (Vref), such as the low logic voltage, the comparator 501b outputs the preset low-level voltage for the voltage of the bit.

As explained above, the high-level voltage value is about 3.3V. The low-level voltage value is 0V. Accordingly, the digital data signal (Data) is converted to the restored digital data signal (Data′) of about 3.3V by the comparator 501b . In the meantime, as the digital data signal (Data) outputted from the timing controller 330 passes through the data transmission line 444, the digital data signal (Data) can be distorted due to the resistance and the capacitance components of data transmission line 444. Accordingly, the voltage for each bit of the digital data signal (Data) may be smaller or larger than the desired value.

To prevent misoperation of the comparator 501b caused by the distortion of the digital data signal (Data), the reference voltage (Vref) is changed based on the distortion of the digital data signal (Data), which will be explained in reference to FIG. 6, which illustrates a waveform of reference voltage outputted from a reference voltage generator of FIG. 5. The digital data signal (Data) has a voltage level similar to the clock signal (CLK). The voltage of the bits of the high logic voltage from the digital data signal (Data) is identical in voltage level to the voltage of bits of the high logic voltage from the clock signal (CLK). Also, the voltage of bits of the low logic voltage from the digital data signal (Data) is identical in voltage level to the voltage of bits of the low logic voltage from the clock signal (CLK). The data transmission line 444 is similar in length to the clock transmission line 555. Further, the data transmission line 444 is positioned adjacent to the clock transmission line 555.

Accordingly, the digital data signal (Data) transmitted through the data transmission line 444 and the clock signal (CLK) transmitted through the clock transmission line 555 are distorted by similar resistance and capacitance components that distort the data transmission line 444. Thus, the change in peak to peak voltage of the digital data signal (Data) is very similar to the change in peak to peak voltage of the clock signal (CLK). Accordingly, the change of the digital data signal (Data) is analogous to the change of the clock signal (CLK).

The reference voltage generator 501 a senses the voltage level of the clock signal (CLK) periodically. More particularly, the reference voltage generator 501a reads the voltage level of high and low logic voltages of the clock signal (CLK), and generates the reference voltage (Vref) of an intermediate voltage between the high and low logic voltages. Even though the voltage level of the clock signal (CLK) changes, as shown in FIG. 6, the reference voltage (Vref) generated from the reference voltage generator 501a corresponds to the intermediate voltage between the high and low logic voltages of the clock signal (CLK). As explained above, the changes in the clock signal (CLK) are reflected in the digital data signal (Data). Accordingly, the reference voltage (Vref) has an intermediate voltage between the high and low logic voltages of the digital data signal (Data).

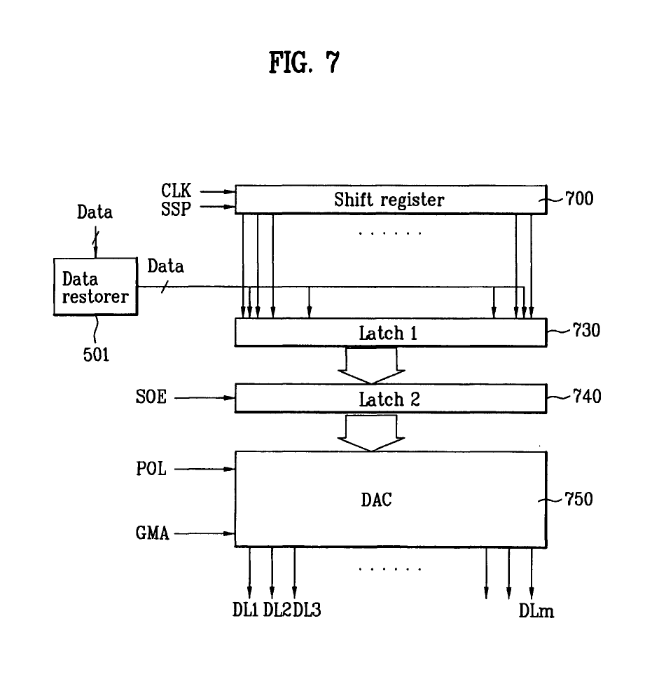

FIG. 7 is a schematic view of the data driver IC in FIG. 3. As shown in FIG. 7, the data driver IC 340 includes the above-explained data restorer 501, a shift register 700, a first latch 730, a second latch 740, and a digital-analog converter 750. The shift register 700 generates sampling signal using the clock signal (CLK) and a source start pulse (SSP) in response to the data control signal (DCS) outputted from the timing controller 330. The first latch 730 sequentially samples the digital data signal (Data) for one line supplied from the data restorer according to the sampling signal. Simultaneously, the second latch 740 outputs the digital data signal (Data) for one line sampled by the first latch 730 according to a source enable signal (SOE) among the data control signal (DCS). The digital-analog converter 750 converts the digital data signal (Data) for one line supplied from the second latch 740 to the analog data signal, and supplies the analog data signal to the data lines (DL1 to DLm) of the LCD panel 310.

In the LCD device and method for driving the same according to embodiments of the present invention, the reference voltage generator reads the voltage level of the clock signal, changes the voltage level of the reference voltage according to the read result, and outputs the changed voltage level as the reference voltage. Since the change of clock signal is reflected in the change of digital data signal, the reference voltage outputted from the reference voltage generator is changed to accommodate the changes in the voltage level of the digital data signal. Accordingly, even though the voltage level of digital data signal is distorted, the reference voltage corresponds to the intermediate voltage of the digital data signal. Thus, misoperation of the comparator is prevented.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A liquid crystal display device comprising:
a timing controller for outputting a digital data signal to display images and a clock signal to sample the digital data signal; and
a data restorer for generating a reference voltage based on the clock signal from the timing controller, comparing a voltage of digital data signal outputted from the timing controller with the reference voltage, converting the voltage of digital data signal to one of preset voltages, and supplying the converted voltage to a data driver integrated circuit.

2. The liquid crystal display device of claim 1, wherein the data restorer includes:
a reference voltage generator for outputting the reference voltage with an intermediate voltage between first and second voltages of the clock signal; and
a comparator for comparing a voltage of digital data signal outputted from the timing controller with the reference voltage, converting the voltage of the digital data signal to any one of preset voltages, and supplying the converted voltage to the data driver integrated circuit.

3. The liquid crystal display device of claim 2, further comprising:
a plurality of data transmission lines for transmitting the digital data signal outputted from the timing controller to the comparator; and
a plurality of clock transmission lines for transmitting the clock signal outputted from the timing controller to the reference voltage generator.

4. The liquid crystal display device of claim 3, wherein the data transmission line and the clock transmission line have similar resistance and capacitance components.

5. The liquid crystal display device of claim 2, wherein the comparator receives the digital data signal by bit, and compares a voltage for each bit with the reference voltage.

6. The liquid crystal display device of claim 4, wherein the comparator converts the voltage of corresponding bit to preset high-level voltage if the voltage of corresponding bit is larger than the reference voltage, and the comparator converts the voltage of corresponding bit to preset low-level voltage if the voltage of corresponding bit is smaller than the reference voltage.

7. The liquid crystal display device of claim 6, wherein the high-level voltage is about 3.3V.

8. The liquid crystal display device of claim 6, wherein the low-level voltage is 0V.

9. The liquid crystal display device of claim 1, wherein the digital data signal outputted from the timing controller has the voltage between about 0.6V and 1.5V.

10. The liquid crystal display device of claim 1, wherein the data driver integrated circuit includes:
a shift register for generating sampling signals using the clock signal and a source start pulse from the timing controller;
a latch for latching the digital data signal outputted from the data restorer according to the sampling signal; and
a digital-analog converter for converting the digital data signal outputted from the latch to an analog signal, and supplying the analog signal to an LCD panel.

11. The liquid crystal display device of claim 10, wherein the data restorer is mounted inside the data driver integrated circuit.

12. The liquid crystal display device of claim 1, further comprising a reference gamma voltage generator which supplies a reference gamma voltage to the data driver integrated circuit.

13. The liquid crystal display device of claim 1, further comprising a liquid crystal display panel which displays images with the analog data signal outputted from the data driver integrated circuit.

14. The liquid crystal display device of claim 13, further comprising a plurality of gate driver integrated circuits for driving gate lines of the liquid crystal display panel.

15. The liquid crystal display device of claim 14, further comprising a gate tape carrier package on which the gate driver integrated circuits are mounted.

16. The liquid crystal display device of claim 1, further comprising a data tape carrier package on which the data driver integrated circuits are mounted.

17. The liquid crystal display device of claim 16, further comprising a printed circuit board connected to a liquid crystal display device panel through the data tape carrier package.

18. The LCD device of claim 17, wherein the timing controller is mounted on the printed circuit board.

19. A method for driving a liquid crystal display device having a liquid crystal display panel for displaying images, comprising:
outputting a digital data signal to display images;
outputting a clock signal to sample the digital data signal;
generating a reference voltage that is an intermediate voltage of the clock signal;
comparing a voltage of the digital data signal with the reference voltage; and
converting the voltage of digital data signal to any one of preset voltages according to the compared result.

20. The method of claim 19, wherein the reference voltage corresponds to the intermediate voltage of first and second voltages of the clock signal.

21. The method of claim 19, further comprising:
generating a sampling signal using the clock signal and a source start pulse;
latching the converted digital data signal according to the sampling signal; and
converting the latched digital data signal to an analog signal.

22. The method of claim 19, wherein the comparing the voltage level of the digital data signal with the reference voltage includes:
outputting the digital data signal by bit; and
comparing the voltage of voltage for each bit with the reference voltage.

23. The method of claim 22, wherein the modulating the digital data signal by comparing the voltage of digital data signal with the reference voltage includes:
modulating the voltage of corresponding bit to a preset high-level voltage if the voltage of corresponding bit is larger than the reference voltage; and
modulating the voltage of corresponding bit to a preset low-level voltage if the voltage of corresponding bit is smaller than the reference voltage.

24. The method of claim 23, wherein the high-level voltage corresponds to about 3.3V.

25. The method of claim 23, wherein the low-level voltage corresponds to 0V.

26. The method of claim 19, wherein the digital data signal has the voltage level between about 0.6V and 1.5V.
